(19) United States
(12) Patent Application Publication
(10) Pub. No.: US 2018/0076560 A1
(43) Pub. Date: Mar. 15, 2018

(54) CARD EDGE CONNECTOR HAVING WIPING DUMMY CONTACT

(71) Applicant: FOXCONN INTERCONNECT TECHNOLOGY LIMITED, Grand Cayman (KY)

(72) Inventor: Wen-Jun TANG, Kunshan (CN)

(21) Appl. No.: 15/702,185

(22) Filed: Sep. 12, 2017

(30) Foreign Application Priority Data
Sep. 12, 2016 (CN) 201610816826.4

(51) Int. Cl. H01R 13/52; H01R 12/72; H01R 13/04

(52) U.S. Cl. CPC H01R 13/52; H01R 2201/06; H01R 13/04; H01R 12/721

(57) ABSTRACT

A card edge connector includes an insulative elongated housing and a plurality of contacts disposed in the housing. The housing includes a pair of side walls extending along a longitudinal direction with a central slot therebetween in a transverse direction perpendicular to the longitudinal direction. Each side wall includes a plurality of passageways to receive the corresponding contacts, respectively. Each contact has the retaining section, a contacting section extending from one side of the retaining section, and a tail section extending from the other side of the retaining section. Each contact at a lower position is associated with a corresponding wiping terminal at an upper position in the same passageway.

### BACKGROUND OF THE DISCLOSURE

### 1. Field of the Disclosure

The invention is a card edge connector, and particularly to the electrical connector having the corresponding contact associated with a wiping dummy contact above.

### 2. Description of Related Arts

China Patent No. CN201549656U discloses a card edge connector having the contact with aligned dual contacting points. U.S. Pat. No. 7,637,783 discloses a card edge connector having the contact with aligned dual contacting beams. Anyhow, it is expected to provide the wiping action upon the corresponding conductive pad of the memory card during mating. In the aforementioned both designs, the upper contacting point is derived from the corresponding contacting beams extending from the tail of the contact, thus tending to be relatively too resilient and failing to perform the desired wiping action.

A card edge connector having the contacts associated with the corresponding mechanism to provide the expected wiping action, is desired

### SUMMARY OF THE DISCLOSURE

A card edge connector includes an insulative elongated housing and a plurality of contacts disposed in the housing. The housing includes a pair of side walls extending along a longitudinal direction with a central slot therebetween in a transverse direction perpendicular to the longitudinal direction. Each side wall includes a plurality of passageways to receive the corresponding contacts, respectively. Each contact has the retaining section, a contacting section extending from one side of the retaining section, and a tail section extending from the other side of the retaining section. Each contact is associated with a corresponding wiping terminal in the same passageway wherein the wiping action is located above the contact and the contacting point of the contact is aligned with that of the wiping terminal in the vertical direction perpendicular to both the longitudinal direction and the transverse direction. The wiping terminal is downwardly assembled into the corresponding passageway and includes a body shorter than that of the contact for performing the expected wiping effect upon the corresponding conductive pad of the memory module which is inserted into the central slot.

### BRIEF DESCRIPTION OF THE DRAWINGS

FIG. 1 is a perspective view of an electrical card edge connector with a corresponding memory module according to the invention;

FIG. 2 is a perspective view of the electrical card edge connector of FIG. 1 with the memory module inserted thereinto;

FIG. 3 is a perspective view of the electrical card edge connector of FIG. 1;

FIG. 4 is another perspective view of the electrical card edge connector of FIG. 3;

FIG. 5 is a partially exploded perspective view of the electrical card edge connector of FIG. 4;

FIG. 6 is another partially exploded perspective view of the electrical card edge connector of FIG. 5;

FIG. 7 is an enlarged partial perspective view of the electrical card edge connector of FIG. 5;

FIG. 8 is an enlarged perspective view of the contact of the electrical card edge connector of FIG. 7;

FIG. 9 is a cross-sectional view of the electrical card edge connector of FIG. 3;

FIG. 10 is a cross-sectional view of the electrical card edge connector of FIG. 1 with the memory module inserted therein;

### DETAILED DESCRIPTION OF THE PREFERRED EMBODIMENT

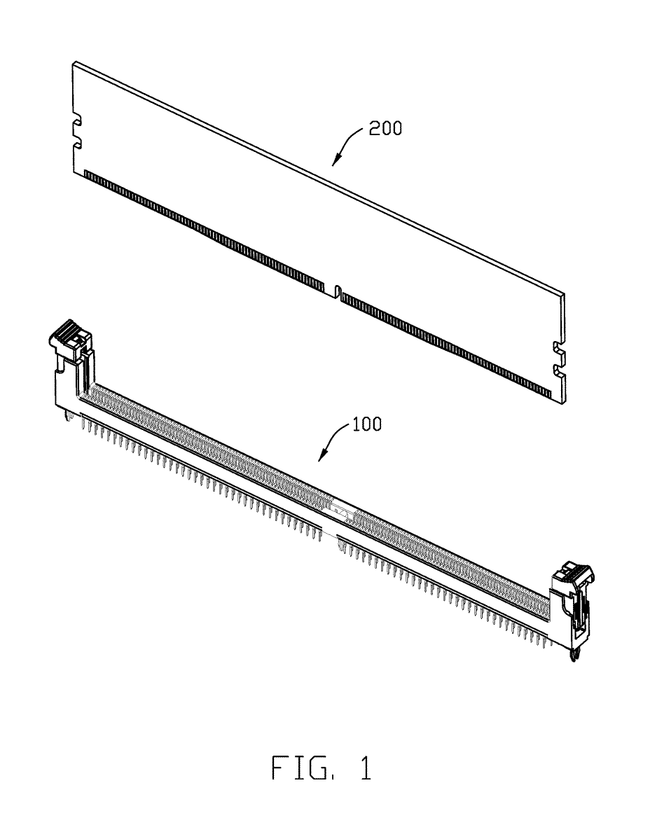

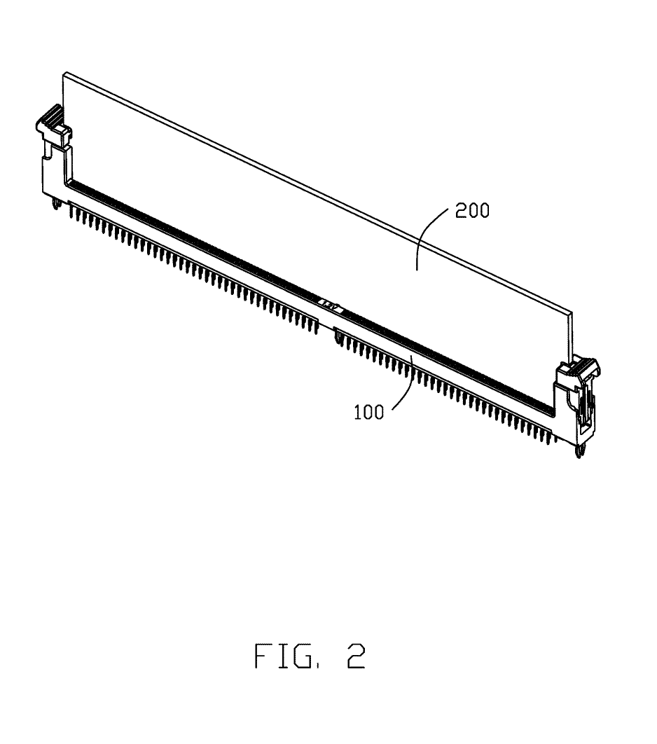

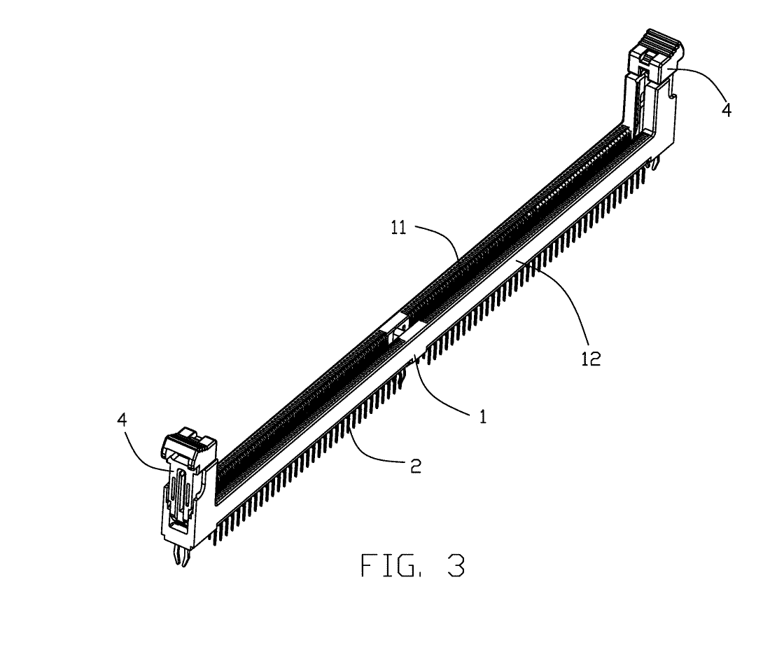

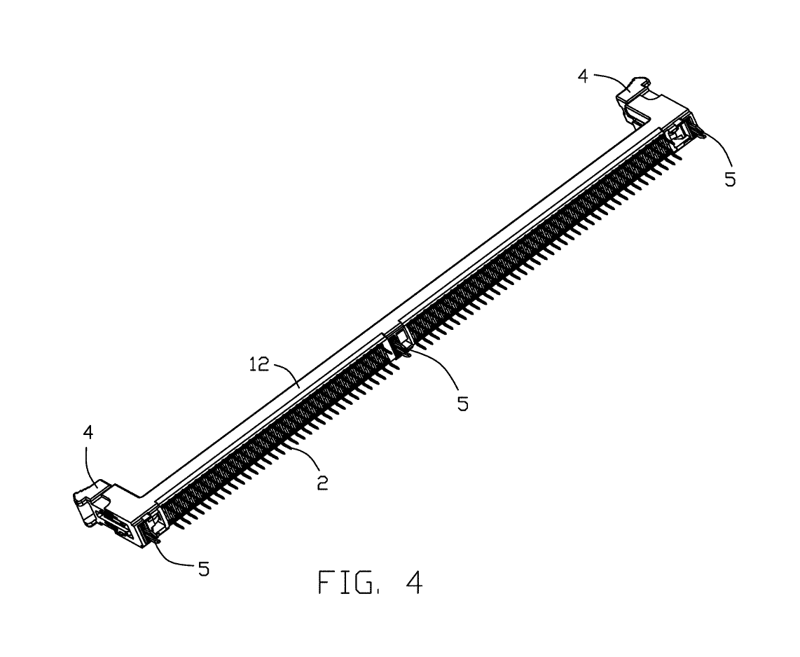

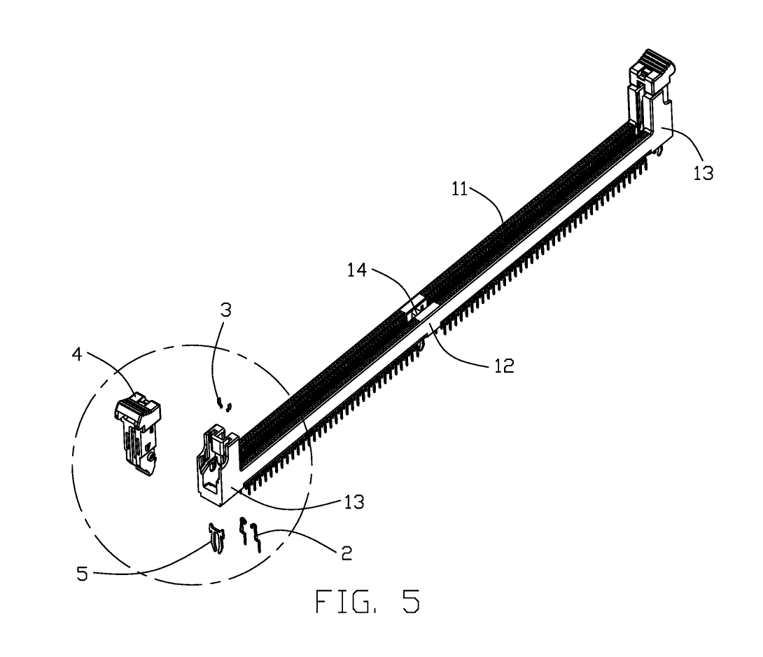

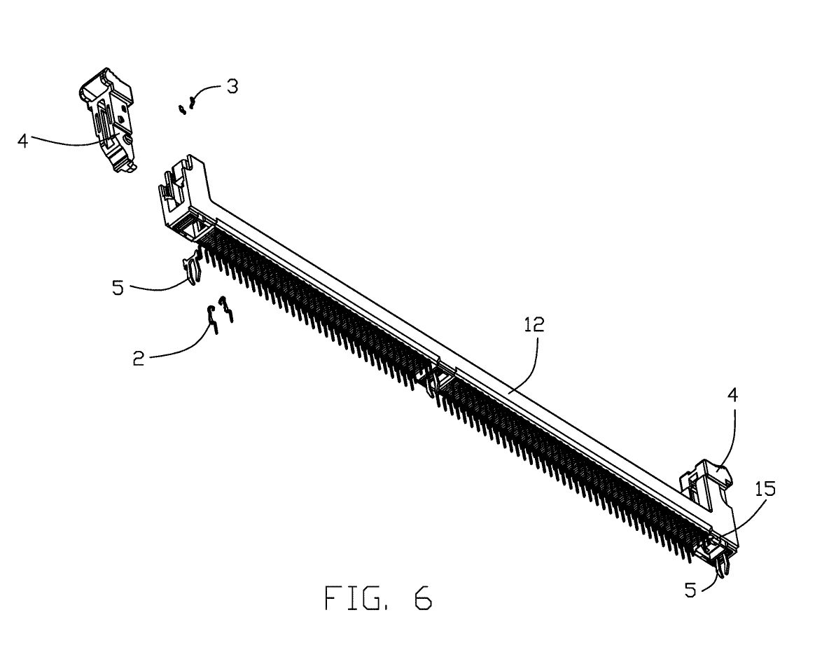

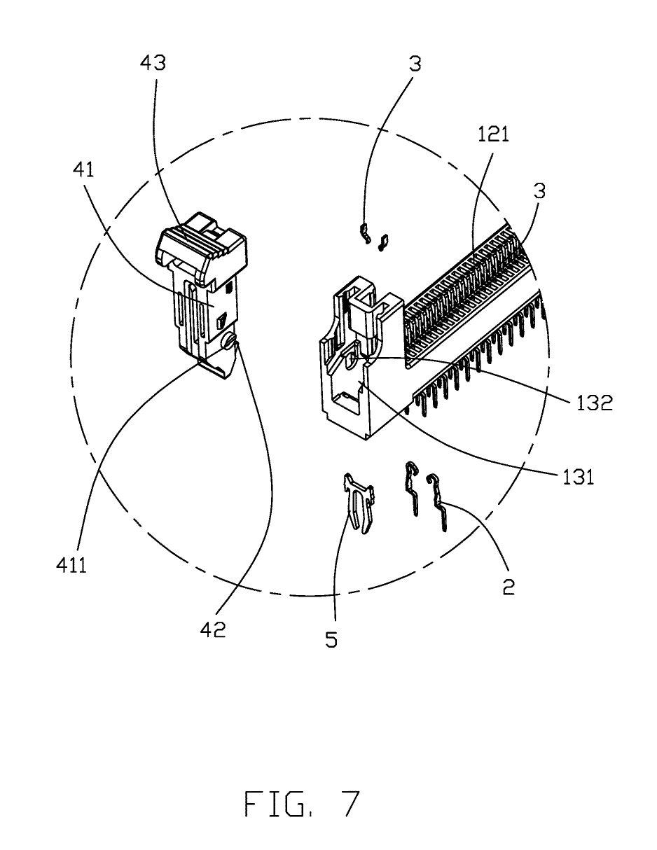

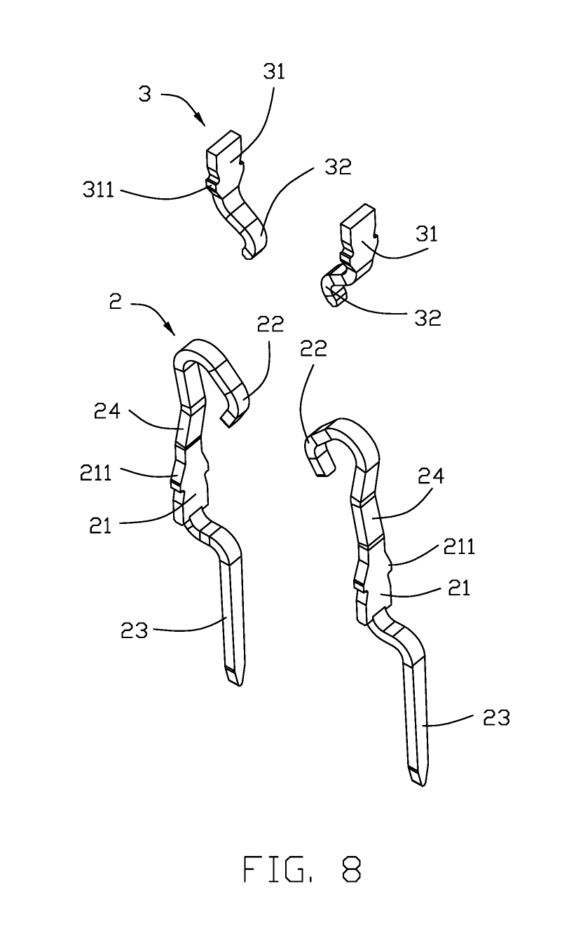

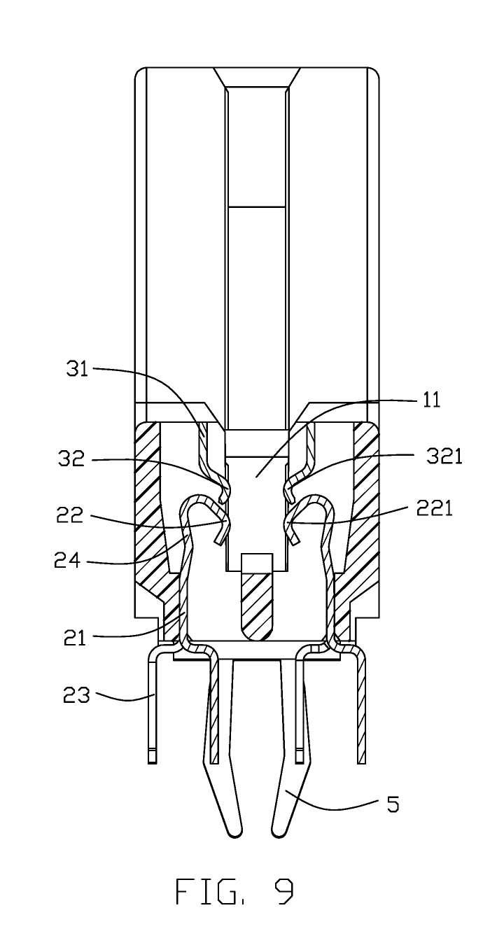

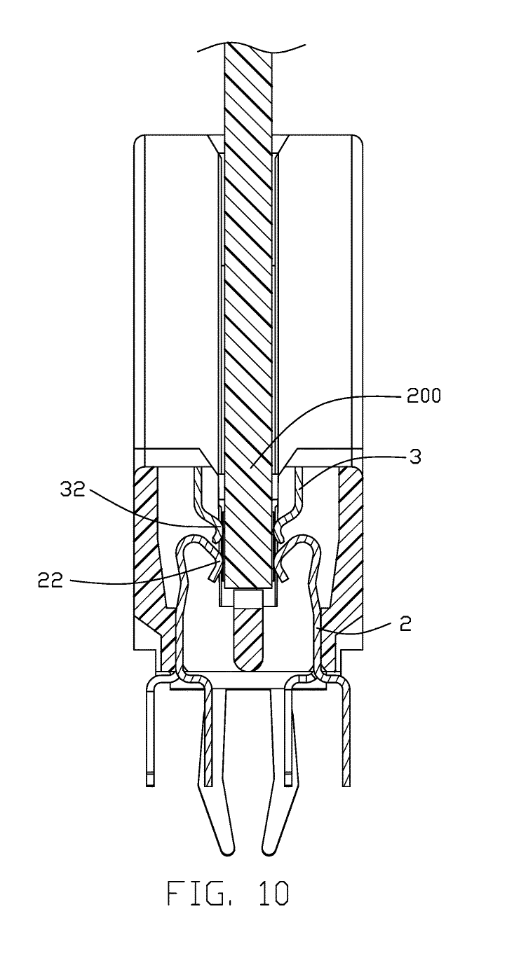

Referring to FIGS. 1-10, an electrical card edge connector 100 includes an elongated insulative housing 1, a plurality of contacts 2, a plurality of wiping terminals or dummy contacts 3 respectively associated with the corresponding contacts, the ejectors 4 and the board locks 5.

The housing 1 includes a pair of side walls 12 extending along the longitudinal direction with a central slot 11 therebetween in the transverse direction perpendicular to the longitudinal direction, and a pair of towers 13 located by two ends of the housing 1. A key 14 is located in the central slot 11 to divide the central slot 11 into two different segments. A plurality of passageways 121 extend through each of the side walls 12 in a vertical direction perpendicular to both the longitudinal direction and the transverse direction. Each contact 2 includes a retaining section 21, a contacting section 22 extending form one side of the retaining section 21 and into the central slot 11, and a tail/mounting section 23 extending from the other side of the retaining section 21 and exposed outside of the housing 1. The retaining section 21 forms barbs 211 on two sides for engagement with the side wall 12. An extension section 24 is located between the contacting section 22 and the retaining section 21. The mounting sections 23 are arranged with four rows totally. Similarly, the terminal 3 includes a retaining portion 31 and a wiping portion 32 extending from the retaining portion 31 and into the central slot 11 wherein the mounting section 23 forms barbs 311 on two sides for engagement with the side wall 12. Notably, each terminal 3 is not equipped with the tail/mounting portion for connecting to the printed circuit board. In other words, different from the dual function of the dual contacting points during operation in the aforementioned traditional connector, the invention is to provide only one contacting point during operation. Understandably, in the instant invention the additional contacting point is only for wiping the corresponding conductive pad during mating rather than electrical connection with conductive pad during operation with the inserted memory module.

Each passageway 121 receives one contact 2 and one corresponding wiping terminal 3 wherein the wiping terminal 3 is downwardly inserted into the passageway 121 while the contact 2 is upwardly inserted into the passageway 121. The terminal 3 occupies upper one third of the height of the corresponding passageway 121 while the contacts occupies lower two thirds of the height of the corresponding passageway 121. Notably, the contacting point 321 of the terminal 3 is aligned with and located above the contacting point 221 of the contacting section 22 of the contact 2 so as to efficiently wipe the corresponding conductive pad before such a conductive pad is mechanically and electrically connected to the corresponding contacting section 22 of the contact 2 for superior connection therebetween. The contacting section 22 is of the upside-down bellow type while the wiping portion 32 is of the downward cantilevered type. In this embodiment, the retaining section 21 of the contact 2 essentially abuts against and intimately located upon an interior surface of the corresponding passageway 121 in the transverse direction while the retaining portion 31 of the terminal 3 is essentially and intentionally offset from the retaining section 121 of the corresponding contact 2 in the transverse direction for avoiding jeopardizing the structure of the same passageway 121 in the corresponding side wall 12 due to interference occurring upon the same position in the vertical direction.

The tower 13 includes a receiving cavity 131 and the ejector 4 is received in the receiving cavity 131 for locking the memory module 200. The ejector 4 includes a main body 41, a kicker 42 located at the bottom portion of the main body 41, and a handler 43 located at the top portion of the main body 41. The tower 13 includes a pivot groove 132 to receive the pivot shaft 411 of the main body 41 whereby the ejector 4 is rotatable in the receiving cavity 131. The ejector 4 is rotated to a locking position by downward movement of the memory module 200 against the kicker 42, and is rotated to a unlocking position by sidewardly pressing the handler 43 to eject the memory module 200. The board lock 5 attached to an underside of the housing 1 for mounting the connector 100 upon the printed circuit board.

While a preferred embodiment in accordance with the present disclosure has been shown and described, equivalent modifications and changes known to persons skilled in the art according to the spirit of the present disclosure are considered within the scope of the present disclosure as described in the appended claims.

What is claimed is:

1. An electrical connector for receiving a memory module therein, comprising:
an elongated insulative housing having a pair of side walls extending along a longitudinal direction with a central slot therebetween in a transverse direction perpendicular to said longitudinal direction;
a plurality of passageways extending through each of said side walls in a vertical direction perpendicular to both said longitudinal direction and said transverse direction;
each of said passageways being equipped with a contact and a wiping terminal discrete from each other wherein the contact has a retaining section, a contacting section extending from one side of the retaining section and into the central slot, and a mounting section extending from the other side of the retaining section and out of the housing for mounting to a printed circuit board, and the terminal is located above the contact and has a retaining portion and a wiping portion extending from one side of the retaining portion and into the central slot; wherein
said terminal has no means for mounting to the printed circuit board.

2. The electrical connector as claimed in claim 1, wherein the wiping portion forms an upper contacting point while the contacting section forms a lower contacting point aligned with and located under the upper contacting point in the vertical direction.

3. The electrical connector as claimed in claim 1, wherein in each of said passageways, the retaining section of the corresponding contact and the retaining portion of the corresponding terminal is not aligned with each other in the vertical direction but being offset from each other in the transverse direction.

4. The electrical connector as claimed in claim 3, wherein the retention section of the corresponding contact abuts against an interior surface of the corresponding side wall while the retention portion of the corresponding is located between the central slot and the corresponding side wall.

5. The electrical connector as claimed in claim 1, wherein said contacts are configured to be upwardly assembled into the corresponding passageways while said terminals are configured to be downwardly assembled into the corresponding passageways..

6. The electrical connector as claimed in claim 1, wherein the terminal occupies upper one third of a height of the corresponding passageway while the contact occupies lower two thirds of the height of the corresponding passageway in the vertical direction.

7. The electrical connector as claimed in claim 1, wherein the wiping portion is of a downward cantilevered type while the contacting section is of an upside-down bellow type.

8. An electrical connector for receiving a memory module therein, comprising:
an elongated insulative housing having a pair of side walls extending along a longitudinal direction with a central slot therebetween in a transverse direction perpendicular to said longitudinal direction;
a plurality of passageways extending through each of said side walls in a vertical direction perpendicular to both said longitudinal direction and said transverse direction;
each of said passageways being equipped with a contact and a wiping terminal discrete from each other wherein the contact has a retaining section, a contacting section extending from one side of the retaining section and into the central slot, and a mounting section extending from the other side of the retaining section and out of the housing for mounting to a printed circuit board, and the terminal is located above the contact and has a retaining portion and a wiping portion extending from one side of the retaining portion and into the central slot; wherein
in each of said passageways, the corresponding terminal is shorter than the contact in the vertical direction.

9. The electrical connector as claimed in claim 8, wherein the wiping portion forms an upper contacting point while the contacting section forms a lower contacting point aligned with and located under the upper contacting point in the vertical direction.

10. The electrical connector as claimed in claim 8, wherein in each of said passageways, the retaining section of the corresponding contact and the retaining portion of the corresponding terminal is not aligned with each other in the vertical direction but being offset from each other in the transverse direction.

11. The electrical connector as claimed in claim 10, wherein the retention section of the corresponding contact abuts against an interior surface of the corresponding side wall while the retention portion of the corresponding is located between the central slot and the corresponding side wall.

12. The electrical connector as claimed in claim 8, wherein said contacts are configured to be upwardly assembled into the corresponding passageways while said terminals are configured to be downwardly assembled into the corresponding passageways.

13. The electrical connector as claimed in claim 8, wherein the terminal occupies upper one third of a height of the corresponding passageway while the contact occupies lower two thirds of the height of the corresponding passageway in the vertical direction.

14. The electrical connector as claimed in claim 8, wherein the wiping portion is of a downward cantilevered type while the contacting section is of an upside-down bellow type.

15. An electrical connector for receiving a memory module therein, comprising:
an elongated insulative housing having a pair of side walls extending along a longitudinal direction with a central slot therebetween in a transverse direction perpendicular to said longitudinal direction;
a plurality of passageways extending through each of said side walls in a vertical direction perpendicular to both said longitudinal direction and said transverse direction;
each of said passageways being equipped with a contact and a wiping terminal discrete from each other wherein the contact has a retaining section, a contacting section extending from one side of the retaining section and into the central slot, and a mounting section extending from the other side of the retaining section and out of the housing for mounting to a printed circuit board, and the terminal is located above the contact and has a retaining portion and a wiping portion extending from one side of the retaining portion and into the central slot; wherein
the wiping portion forms an upper contacting point while the contacting section forms a lower contacting point aligned with and located under the upper contacting point in the vertical direction.

16. The electrical connector as claimed in claim 15, wherein in each of said passageways, the retaining section of the corresponding contact and the retaining portion of the corresponding terminal is not aligned with each other in the vertical direction but being offset from each other in the transverse direction.

17. The electrical connector as claimed in claim 16, wherein the retention section of the corresponding contact abuts against an interior surface of the corresponding side wall while the retention portion of the corresponding is located between the central slot and the corresponding side wall.

18. The electrical connector as claimed in claim 15, wherein said contacts are configured to be upwardly assembled into the corresponding passageways while said terminals are configured to be downwardly assembled into the corresponding passageways

19. The electrical connector as claimed in claim 15, wherein the terminal occupies upper one third of a height of the corresponding passageway while the contact occupies lower two thirds of the height of the corresponding passageway in the vertical direction.

20. The electrical connector as claimed in claim 15, wherein the wiping portion is of a downward cantilevered type while the contacting section is of an upside-down bellow type
